(19) United States
(12) Patent Application Publication
(10) Pub. No.: US 2007/0227556 A1
(43) Pub. Date: Oct. 4, 2007

(54) METHODS FOR REMOVING PHOTORESIST

(76) Inventor: Eric J. Bergman, Kalispell, MT (US)

Correspondence Address: PERKINS COIE LLP/SEMITOOL, PO BOX 1208, SEATTLE, WA, 98111-1208, US

(21) Appl. No.: 11/689,987

(22) Filed: Mar. 22, 2007

Related U.S. Application Data
(60) Provisional application No. 60/744,254, filed on Apr. 4, 2006.
(60) Provisional application No. 60/862,009, filed on Oct. 18, 2006.

(51) Int. Cl. C23G 1/00; C23G 1/02; B08B 7/00; B08B 3/00

(52) U.S. Cl. 134/3; 134/26; 134/33; 134/2; 134/28; 134/137; 134/94.1; 134/149

(57) ABSTRACT

In a method for removing an organic film such as photoresist from a wafer, the wafer is placed into a chamber. A liquid including an acid, such as sulfuric acid is applied to the surface of the wafer. Sulfur trioxide is supplied into the chamber. Alternatively, fuming sulfuric acid may be used. The wafer may optionally be spinning in the chamber. The liquid forms a liquid layer on the surface of the workpiece. The chemical reaction of the acid and the SO₃ removes the organic film. Further improved results may be achieved in removing many organic films by heating the wafer, or the liquid, or both. Providing ozone gas into the chamber may also be helpful in some applications. In a related method, an organic film is removed from a wafer by applying an acid film or layer on to the surface of the wafer. The acid, is heated. An oxidizer is then delivered to the heated acid film. The combined action of the acid and the oxidizer removes the organic film, typically without leaving any residues. The acid may be sulfuric acid and the oxidizer may be hydrogen peroxide.

### PRIORITY CLAIM FOR THE UNITED STATES

This Application claims priority to U.S. Provisional Patent Application Nos. 60/744,254 filed Apr. 4, 2006 and 60/862,009, both incorporated herein by reference. Thus novel methods and apparatus have been shown and described. Various changes and substitutions may of course be made without departing from the spirit and scope of the invention. The invention, therefore, should not be limited, except by the following claims and their equivalents. Where not inconsistent with the context, singular terms include the plural, and vice versa. Similarly, use of the term “or” here may mean “or” or “and/or”.

### BACKGROUND

Semiconductor wafer patterns are typically created by applying a photoresist to the wafer surface. Exposing a pattern on the wafer alters the chemical bonding of the photoresist, which allows certain regions to be removed using a developer while other regions become relatively inert to the developer. Photoresist may be either positive or negative, which denotes whether the light-exposed region or the non-light exposed region is removed in the developer. In either case, a pattern is created on the wafer which is used to mask the covered regions. The masking effect will protect the underlying layer from the effects of various etchants and from ion implants. Following such processing, the photoresist must then be removed.

Historically, photoresist has been removed by plasma ashing in an oxygen, ozone, or nitrous oxide containing environment, by oxidation in sulfuric acid or sulfuric acid and hydrogen peroxide mixtures, or by removal in ozone/water solutions. Photoresist dissolution in organic solvents is also used, though this is typically reserved for semiconductor wafers which have metal films or patterns present which might be attacked by strong oxidizing environments.

Various wet process chemicals have been used to remove photoresist. However, in many cases the prior processing of the wafer may have hardened or cross-linked the photoresist to an extent that the liquid chemicals are no longer effective in removing the photoresist Hardening of the photoresist may be due to excessive plasma exposure during an etch process. Photoresist hardening is also very common when ion implantation occurs, for example, at a dosage above 1E15 atoms/cm². Plasma ashing and dry ozone ashing are very effective at removing hardened photoresist. However, these processes can cause degradation of device performance due to plasma damage, the potential for hot-electron injection, mobile ion migration and surface attack. Consequently, there is a need for new techniques for removing hardened photoresist, without detrimental effects to the semiconductor devices being manufactured.

### BRIEF STATEMENT OF THE INVENTION

Sulfuric acid and hydrogen peroxide have been used for many years in efforts to strip or remove photoresist, with varying degrees of success. It has now been discovered however, that the sequence and parameters of their use can greatly affect the strip performance. It has now also been discovered that use of fuming sulfuric acid, or sulfur trioxide used in a liquid phase, also provides unexpectedly improved results.

In methods for removing an organic film from a workpiece, such as a wafer or substrate, the wafer is placed into a chamber. The chamber is closed or sealed. A liquid including an acid, such as sulfuric acid, is provided onto the surface of the wafer. Where sulfuric acid is used, it may be formed by a de-ionized water layer on the wafer absorbing sulfur trioxide vapor provided into the chamber. Alternatively, sulfuric acid, in liquid form, may be provided onto the wafer surface, or fuming sulfuric acid may be used. The chemical reaction of the acid removes the organic film. Further improved results may be achieved in removing many organic films by heating the wafer, or the liquid, or both. Providing ozone gas into the chamber may also be helpful in some applications.

In a related method, an organic film is removed from a wafer by applying a liquid acid film or layer on to the surface of the wafer. The acid, which may be in a solution with water, is then heated. Temperatures of 25 or 30° C. up to about 320° C., or about 100-220° C. may be used. An oxidizer is then delivered to the heated acid film, typically after a short time interval. The combined action of the acid and the oxidizer removes the organic film, typically without leaving any residues. The acid may be sulfuric acid and the oxidizer may be hydrogen peroxide. When hydrogen peroxide is used after initially providing fuming sulfuric acid, or sulfuric acid and sulfur trioxide, the results are much improved over simply using sulfuric acid and hydrogen peroxide as has been done in the past. The invention resides as well in sub-combinations of the steps described, and also in apparatus that may be used to perform the methods.

### BRIEF DESCRIPTION OF THE DRAWINGS

FIGS. 1-10 are photomicrographs of wafers or wafer fragments processed as described below. FIG. 11 is a schematic diagram of an apparatus that may be used to remove photoresist from a workpiece.

### DETAILED DESCRIPTION

### A. Methods

1. Sulfuric Acid and Sulfur Trioxide

Sulfuric acid (H₂SO₄), and particularly fuming sulfuric (sulfuric acid in conjunction with sulfur trioxide (SO₃)) may be used for stripping photoresist. Fuming sulfuric acid is commonly called oleum and is sulfuric acid with a percentage of sulfur trioxide dissolved in solution. Fuming sulfuric acid may be made by reacting water and SO₃, dissolving SO₃ in H₂SO₄ or by applying SO₃ already dissolved in H₂SO₄. If SO₃ is used, it may be delivered into an enclosed process chamber either by bubbling a carrier gas through the SO₃ or by delivering a pressurized stream of SO₃ to the process chamber. The flow rate may typically be in the range of 0.25-10 liters/minute.

The photoresist on the wafer surface may be initially wetted with water or steam. Spinning the wafer to thin the water film may optionally be used. Even a microscopic wetting of the wafer surface may be advantageous. Water may be supplied prior to or concurrent with the SO₃ delivery to the process chamber.

SO₃ dissolved in sulfuric acid is commercially available in large quantities. The SO₃ content may be specified, and is commonly supplied as 10%, 15%, 20%, 30% and even 65% SO₃ by weight dissolved in H₂SO₄, (known as oleum or fuming sulfuric acid). The potential benefit to using fuming sulfuric acid is that the SO₃ is already dissolved in the liquid and thus made more readily available to react with photoresist. This potentially simplifies both the process equipment and the process itself. The process may be performed by applying fuming sulfuric acid, with or without ozone, to a wafer surface which is heated.

SO₃ may solidify in the lines and the bottle. Accordingly, it may be useful to provide temperature control of various components of the SO₃ delivery system, which may include heating one or more of the bottle, supply lines, outlet lines and valves. Whether using vapor from a liquid SO₃ source or using fuming sulfuric acid, the heating profile may impact the reactivity and availability of the SO₃ to support oxidation on the wafer surface.

2. Ozone

Ozone gas may optionally be used with the fuming sulfuric acid or with sulfuric acid and sulfur trioxide. If sulfur trioxide gas is used, the ozone may be provided into the process chamber with the sulfur trioxide, or it may separately provided into the process chamber. The process chamber may be purged with nitrogen before and/or after processing.

After the SO₃ or fuming sulfuric acid is applied, a delay may be employed prior to delivering a flow of ozone gas to the process chamber. The ozone gas will typically be supplied from an ozone generator, with a flow rate, for example, in the range of 1-10 liters/minute at a concentration (by weight) in oxygen of 5-25%, although other ranges may be used depending on the specific application. The ozone may then purged from the process chamber and the wafer removed and optionally rinsed.

When ozone is used, the liquid film on the wafer surface (regardless of its chemical makeup) should be thin, to promote diffusion of ozone through the liquid film to react at the wafer surface. The liquid film will generally include water, which reacts exothermically with the SO₃ and can help to provide a media for ozone to dissolve into.

If SO₃ is used with ozone (with or without hydrogen peroxide or in a separate application of sulfuric acid), the steam or heated water process as described in U.S. Pat. No. 6,869,487 may be used, with the presence of water enabling the ozone to oxidize photoresist at a much faster rate than it would in the dry state.

3. Heating

The wafer may be heated in combination with step 1 above, or steps and 1 and 2 above. Ramp-up or step-up heating may be used. The wafer and or liquid may be heated in step increments or ramped up quickly to about 90 or 120 to 200° C., or 140 or 160 to 180° C. In a step heating method, the wafer may be heated from ambient to a first temperature of 80-100° C., with a dwell time at this first temperature of e.g., 20-180 seconds, and then with further heating to a second process temperature of 140-180° C. With ramp-up heating, the wafer may be heated directly from ambient temperature to a process temperature of 140-180° C. in e.g., 20-60 seconds.

Heating the substrate improves the efficiency of the strip process. Heating may be accomplished by applying heated liquid, such as water to the backside of a silicon wafer while SO₃, or SO₃ and ozone are applied to the front side of the wafer. Heating may also be achieved via heating lamps outside of the chamber radiating infrared radiation into the chamber through a quartz window, a heated base plate or rotor, or a heated chamber. However, since the boiling point of SO₃ is approximately 44° C., temperatures above this point will push the reaction into the gas phase, which may behave differently from the liquid phase. The processes described here accordingly may be performed at room temperature, or at an elevated temperatures of 25° C. up to 180 or 200° C., which increases the reaction rate of the chemical process. The processes may also be performed at temperatures in the range of 25 or 30° C.-99° C., if there are factors for avoiding higher temperatures. Adding heat is especially significant in removing high-dose implant photoresist. The term “high dose” here refers to implant dosages ≧1E15 atoms/cm2. For these types of photoresist, the wafer may be heated to about 160-180° C. When heating the wafer to these temperature ranges, hot DI rinse water should be used to minimize fracturing or weakening the wafer due to thermal stress. At temperatures above about 90 C., ozone becomes less effective in removing certain photoresists.

4. Oxidizer/Hydrogen Peroxide

An oxidizer such as hydrogen peroxide (H₂O₂) may be provided into or onto the liquid film applied in step 1 in combination with the heating in step 3 above. If used, the hydrogen peroxide may be provided into or onto the liquid film after the wafer and the sulfuric acid have been heated up to a desired temperature. In one form of the process, hydrogen peroxide is provided onto the liquid film after a specified reaction time interval. This is typically accompanied by rapid boiling on the surface as the hydrogen peroxide reacts with the acid, and the mixture of them reacts with the organic contaminant material, such as photoresist, on the wafer surface. This reaction partially or completely oxidizes the organic material. The addition of hydrogen peroxide promotes the oxidizing reactions by creating an exothermic heat of mixing and by producing additional strongly oxidizing species such as Caro's acid, peroxydisulfuric acid, peroxymonosulfuric acid, among others.

The hydrogen peroxide, typically supplied in a 30% by weight solution with water, may be delivered as a liquid stream, spin-on or spray, or applied as vapor or atomized aerosol for more even distribution across and into the sulfuric acid. The hydrogen peroxide may optionally be heated before it is applied, although it may also generally be provided at ambient temperature. Test results suggest that applying the hydrogen peroxide separately from the sulfuric acid, after the sulfuric acid has been applied to the wafer surface and heated to the desired temperature, rather than mixing them in advance and then heating them, may be advantageous. Accordingly, performing steps 1, 2 and 4 may provide improved results with films that are difficult to remove.

After the heating step performed while the fuming sulfuric acid is on the wafer surface, much of the sulfur trioxide in solution will either react with the organic materials on the wafer surface or be driven out of solution due to the heat. The hydrogen peroxide may therefore be introduced after the fuming sulfuric acid. Using hydrogen peroxide in conjunction with fuming sulfuric acid or sulfur trioxide, or used in sequence with fuming sulfuric acid or sulfur trioxide, provides improved performance in removing hardened photoresist. Only a relatively smaller amount of hydrogen peroxide is needed. For example, with about 40 ml of sulfuric acid provided onto the surface of a 300 mm wafer, resulting in e.g., 10-20 ml of acid momentarily present on the surface (the rest being spun off), about 4-12 ml of hydrogen peroxide is used. The volume ratio of sulfuric acid to hydrogen peroxide used is than from about 10:1 up to 1:1, and usually more in the range of about 5:1 to 2:1. In some applications it may be helpful to periodically supply hydrogen peroxide during the reaction time interval while the sulfuric acid is chemically reacting with the surface, rather than only after the reaction time interval. The hydrogen peroxide (as well as the sulfuric acid) may be applied by spraying. It may also be atomized into a fine mist or aerosol. To reduce consumption of process chemicals, the liquid layer of acid on the wafer surface may be maintained relatively thin, e.g., less than 3, 2 or 1 mm. Having a thin liquid layer also better allows for diffusion of ozone gas through the liquid layer, in applications where ozone gas is used.

With some types of photoresist, such as the BF₂ series, a light residue of charred, blackened photoresist may remain after processing. This residue can be removed by applying a small amount of hydrogen peroxide to the wafer surface while it is wetted with a heated film of sulfuric acid or sulfuric acid and sulfur trioxide. The hydrogen peroxide mixing with the heated acid film oxidizes and fully removes the residue. The hydrogen peroxide/acid mixture can be left on the wafer surface e.g., for 30 seconds, with the wafer then rinsed and dried. This process removes photoresist, such as the BF₂ series, which are not effectively removed even with up to 10 minutes of heat and fuming sulfuric exposure or fuming sulfuric used in conjunction with ozone and/or sulfur trioxide vapors.

5. Other Steps and Parameters

Following the steps described above, a water rinse and/or neutralization may be performed. If performed, the rinse step may use sonic cleaning to remove lifted photoresist residues.

After the strip or film removal step, a follow up step may be advantageous to clean the surface of particles and to neutralize sulfate residues. These include immersion or spray hot water rinsing, megasonic cleaning, hot water including ammonium hydroxide, with diffused ozone cleaning, as described in U.S. Pat. No. 6,869,487, or SC1/APM cleans.

A single-chamber clean may be more compatible with the fuming sulfuric acid process, since any moisture in the chamber will react with SO3 vapors to form a white cloud of sulfuric acid vapor, thereby reducing its effectiveness. Both SO₃ and fuming sulfuric acid should be handled with care because mixing them with water can result in a rapid and energetic exothermic reaction. Ordinarily, the flow rate of liquid over the wafer is high enough to moderate the heat generated by mixing with water. Heating the wafer will drive off the SO₃, allowing it to be rinsed with less potential hazard.

The process may be performed at sub-atmospheric pressure, i.e., from ambient pressure down to substantially vacuum conditions. The lower pressure may be used to draw SO₃ into the process chamber and/or to assist in volatilizing the reaction products from the wafer surface. This may also enhance the system safety by ensuring that the SO₃ and Ozone do not leak out of the chamber, since any leak would result in the flow the atmospheric surroundings into the chamber. Alternatively, either process may be performed under pressurized conditions, e.g., at 2-10 or 2-5 times ambient pressure. Higher pressure may be used to increase the ozone concentration, maintain the SO₃ in a liquid state or force the SO₃ and ozone into small geometries and encourage undercut of the photoresist film by attacking an adhesion layer. The flow rates, temperatures, pressures, concentrations, delivery methods, and other parameters described here are representative examples that may be used. They are not, of course, essential and may be varied.

With some photoresist films, Improved results are achieved in the processes described when the wafer is first coated with sulfuric acid. The sulfuric acid alone, when heated to about 160° C. is fairly effective at stripping photoresist. However, better results are realized when the sulfuric acid is used in combination with SO₃ gas or vapor. Even better results may be obtained when SO₃ and ozone are both delivered while the wafer is heated. The wafer surface may be wetted with sulfuric acid. Sulfuric acid is a good wetting agent since it will remain as a liquid at temperatures even above 200° C. The sulfuric acid may be provided by reacting SO₃ and water. This can be accomplished by wetting the wafer surface with water or providing steam or water vapor to the process chamber. Additionally, sulfuric acid can be supplied directly to the wafer. Excess water is detrimental since it requires an excess of SO₃ to create the sulfuric acid.

The organic materials removed from the wafer or workpiece may include photoresist, anti-reflective coatings or other organic contaminants or films such as HMDS. The description here of removing photoresist applies as well to removing these and other organic contaminants. A workpiece or wafer is defined here to include a workpiece formed from a substrate upon which microelectronic circuits or components, data storage elements or layers, and/or micro-mechanical or micro-electro-mechanical elements are formed. The apparatus and methods described here may be used to clean or process workpieces such as semiconductor wafers or articles, as well as other workpieces or objects such as flat panel displays, hard disk media, CD glass, memory media, MEMs devices, optical media or masks, etc.

### B. Discussion

SO₃ has a melting point of approximately 16.8° C. and a boiling point of 44° C. It is a very strong oxidizer, and is also known by the name “sulfuric acid anhydride” since it may react violently with water to form sulfuric acid. The SO₃ may have a high crystal lattice energy, which allows it to solidify in the bottle even when the temperature does not drop below the nominal freezing point.

SO₃ reacts with water as follows:
SO₃+H₂O→H₂SO₄

Hence, one of the alternative names of the chemical SO₃ is “sulfuric acid anhydride,” meaning that sulfuric acid is formed when the compound is mixed with water. One of the primary uses of SO₃ is in fact the manufacture of sulfuric acid. However, this reaction is rarely used in the manufacture of sulfuric acid, because the SO₃ reacts so violently with water. Instead, the following reaction is used:
SO₃+H₂SO₄→H₂S₂O₇ (oleum)
H₂S₂O₇+H₂O→2H₂SO₄

When sulfuric acid contacts SO₃, it may or may not entirely convert to H₂S₂O₇. There is some indication that the H₂S₂O₇ component in sulfuric acid will be in the range of 20-30%, though it is unclear as to whether this is as dissolved SO₃ or as H₂S₂O₇. Regardless of the exact composition, this reaction chain may be useful because it shares characteristics of two other known quasi-stable variants of sulfuric acid. These are:
H₂SO₅ (Caro's acid)
H₂S₂O₈ (peroxy disulfuric acid or PDSA)

Both of these compounds are exceptionally strong oxidizers, and are in fact, compounds which are produced when sulfuric acid is passed through an electrochemical cell over a platinum catalyst or when sulfuric acid is mixed with hydrogen peroxide.

With some types of photoresist, a typical process may be performed in about 3 minutes. For example,

| | | Time |
|---|---|---|
| Step | Function | (mm:ss) |
| 1 | Apply fuming sulfuric acid | 0:10 |
| 2 | Quick Spin while initiating heat to | 0:10 |
| | spread fuming sulfuric across wafer | |
| | surface. | |
| 3 | Heat from ambient to about 90-200 C. or | 0:30 |
| | about 160 C., ozone delivery optional | |
| 4 | Maintain temperature (e.g., at 160 C. or | 2:00 |
| | other selected temperature), ozone | minutes |
| | delivery optional. This step will | or as |
| | generally remove all but the hardest | required |
| | carbonized surface film. | |
| 5 | Optionally apply H2O2 through | 0:02 |
| | atomization nozzles to create aerosol in | |
| | chamber which will settle on and react | |
| | with the fuming sulfuric film on the | |
| | wafer surface to react with and remove | |
| | the hardened carbonized layer. | |
| 6 | Delay to allow time for hydrogen | 0:30 |
| | peroxide to react. | |
| 7 | Optional Rinse: Hot DI water followed | 0:30 |
| | by Cold DI water to step temperature | |
| | down and control thermal stress. May | |
| | use ammonia or TMAH in rinse water to | |
| | eliminate sulfate residues on wafer | |
| | surface. | |
| 8 | Optional Dry | 0:20 |

Water pretreatment is not required. The process outlined in the table above was performed on a wafer implanted with a 193 nm photoresist at 3.5e16 atoms/cm² with good results. In this particular case, the wafer temperature was 160 C., no ozone was used, and H₂O₂ was applied and used in steps 5 and 6. In this example, and others described below, an implant “ghost pattern” may be present on the wafer after processing, due to silicon surface damage in high dose implants.

### C. Experimental Results

An 8 lb. steel bottle of SO₃ was obtained for experimental purposes. The bottle was configured with valves on each end. The purpose of the two valves is to permit attaching a supply of gas to the lower end and bubble the gas through the SO₃ in order to carry small amounts of SO₃ vapor, gas and liquid into a process chamber. The lower end of the bottle was connected to a regulated and metered supply of N₂, with the N₂ flow being controlled by a flow meter. A check valve was installed in-line to prevent the SO₃ from flowing out the lower valve.

The upper valve was connected to a pressure regulator, which proved to be of no value. The outlet from the regulator was connected to a small o-ring sealed process vessel. The test vessel is reasonably suited for use with SO₃ due to the small volume, the fact that the wafer face is readily exposed to the gas/vapor and it is tightly sealed. The SO₃ delivery line was connected in a T-fitting to an N₂ supply in order to purge the SO₃ afterwards. This proved to be only moderately effective since the SO₃ is essentially a liquid at normal room temperature, although a liquid with a fairly high vapor pressure.

Photoresist samples were placed in the process chamber. N₂ at a given flow was bubbled through the SO₃ for a fixed period of time. The process chamber was then purged with N2. The process chamber was then rinsed with DI water, since the SO₃ could not be effectively purged to remove all chemical. The wafer sample was then removed and the resist strip was assessed.

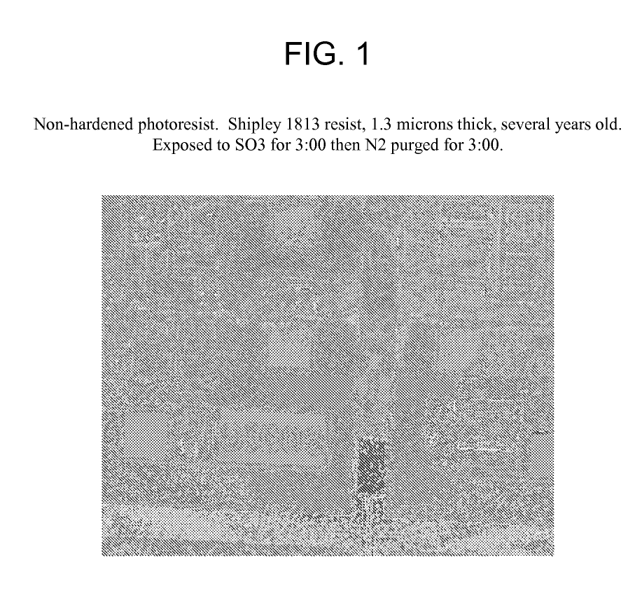

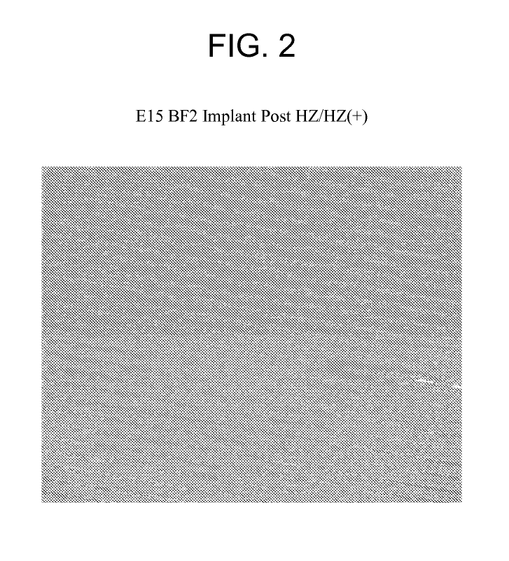

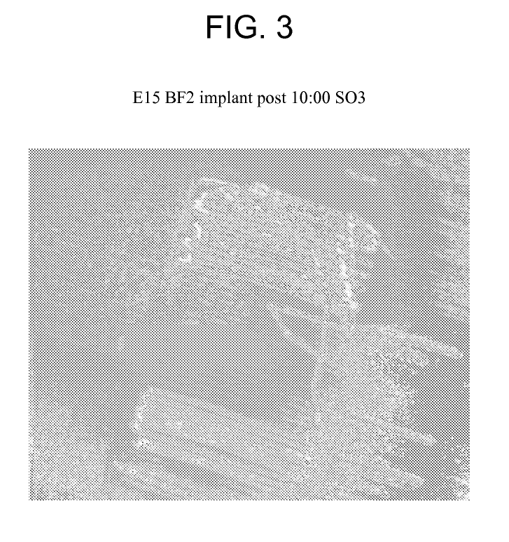

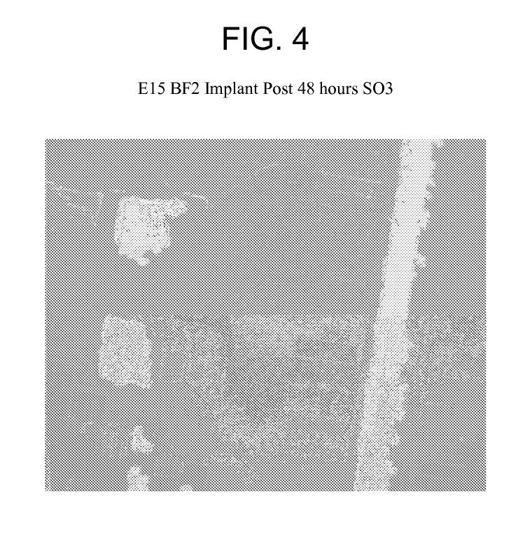

FIGS. 1-6 show the results. FIG. 1 is an image of non hardened photoresist after exposure to SO₃ vapor for 3 minutes. Substantial photoresist remains, demonstrating that, at least in this example, SO₃ alone is not effective in removing the photoresist. FIG. 2 is an image of a sample with an E15 BF2 photoresist, after treatment using a heated water and ozone process (with ammonia) as described for example in U.S. Pat. No. 6,869,487. This example shows that the heated water and ozone process is also not effective in removing this type of high dose implant photoresist. FIG. 3 is an image of a wafer processed in the same way as in FIG. 1, but here for 10 minutes. FIG. 3 shows de-lamination, but not complete removal of the photoresist. FIG. 4 shows a similar sample processed as in FIG. 3, but here for 48 hours, with intermittent supply of SO₃. As shown, unacceptable amounts of photoresist remain after this processing.

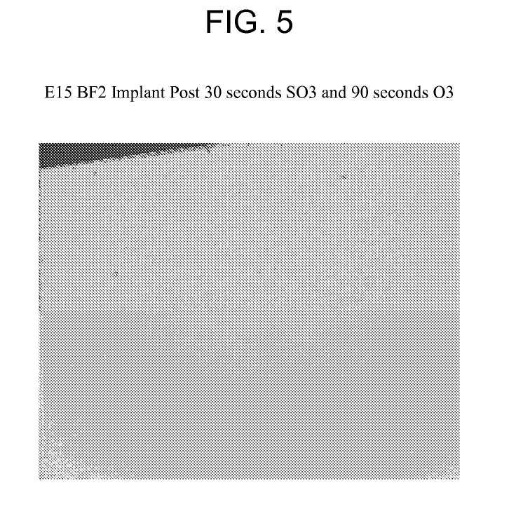

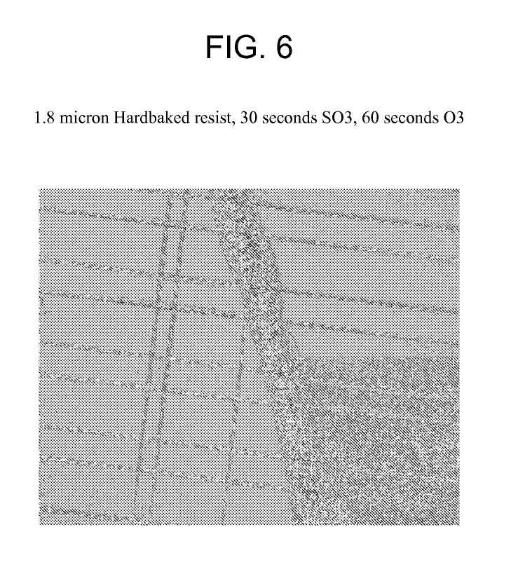

FIG. 5 shows a sample with E15 BF2 photoresist, this time processed with both SO₃ and ozone gas for 90 seconds (in a substantially dry process), and leaving virtually no residual photoresist. In FIG. 5, the black region at the top of the image is the edge of the sample. FIG. 6 shows a 1.8 micron hard baked photoresist sample processed in the same way as in FIG. 5, but with little effect in removing the photoresist. Accordingly, based on these samples, while the SO₃ and ozone process may work well with some samples (as in FIG. 5), it does not work well on other samples. In FIG. 6, the dark and uneven diagonal line is the O-ring seal contact area. The part of the wafer that was protected (the area on the right side of the line) is bulk unprocessed photoresist. The part of the wafer exposed to the SO₃ and ozone shows much of the photoresist remaining.

In order to accomplish the above result shown in FIGS. 5 and 6, an ozone line was connected in a T-fitting into the SO₃ line prior to the process chamber. Two liters of N₂ was bubbled through the SO₃ for 30 seconds. Thirty seconds later, the ozone delivery was initiated for 60-90 seconds, after which the ozone was purged from the chamber with N₂ for 60 seconds and the chamber rinsed prior to removing the sample.

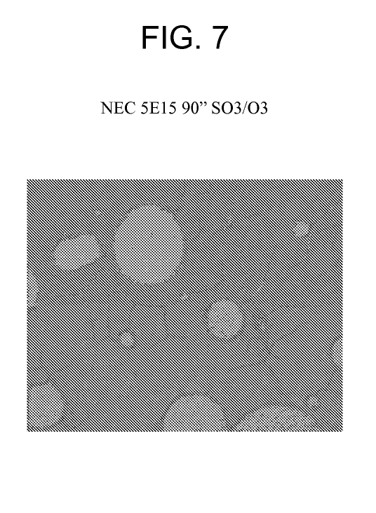

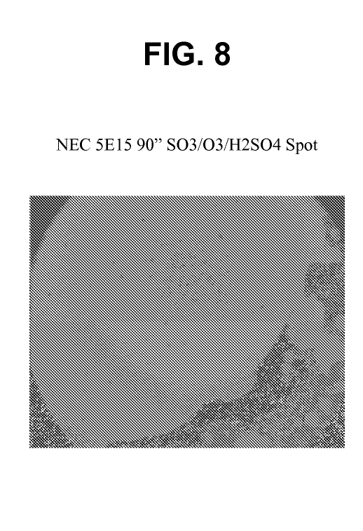

FIG. 7 shows a wafer processed as described above, using SO₃ and ozone. In FIG. 7, the resist is cracking and open spots have appeared, but the resist is largely intact. The open spots appear to be where SO₃ vapor condensed into liquid on the wafer surface. FIG. 8 shows a similar wafer, but with a drop of sulfuric acid applied to the wafer before processing. FIG. 8 shows a large clear region which is where a drop of sulfuric acid had been placed. At the edge of the drop, along the bottom and right edge of the image, is a region which was not wetted by sulfuric acid. This region has a resist residue similar to the residue shown in FIG. 7. In FIG. 8, the regular rounded borders at the left side are artifacts from the microscope used in making the image, and are not on the wafer sample.

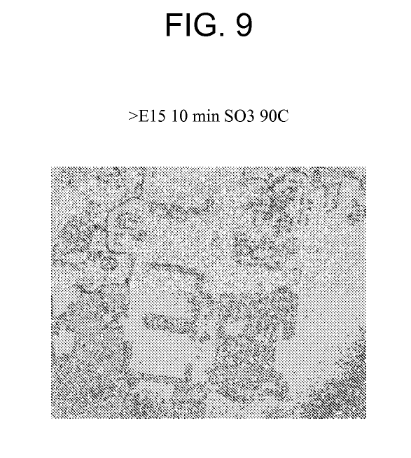

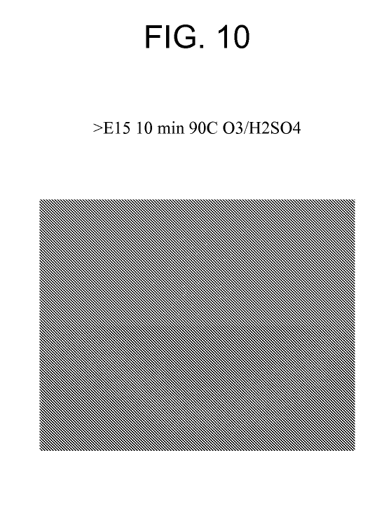

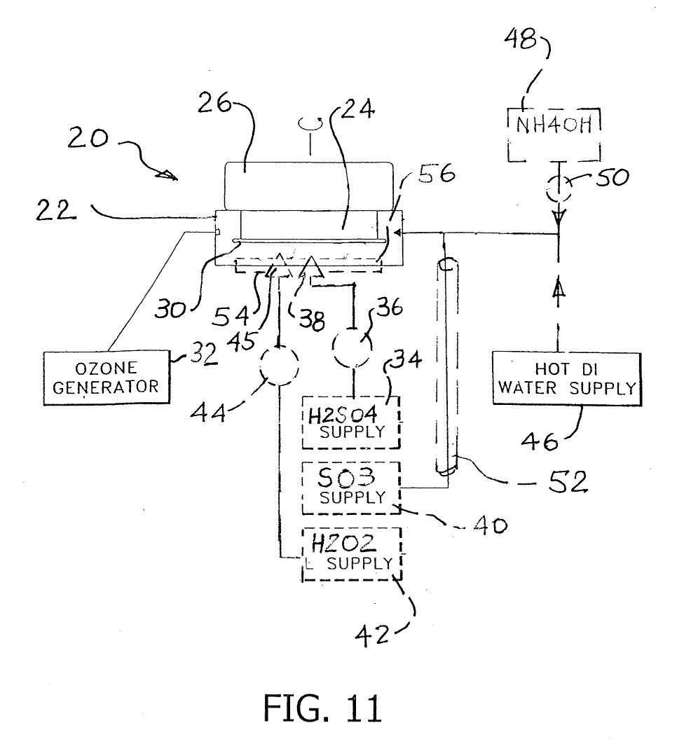

The samples above were processed at or near room temperature. FIG. 9 shows a sample processed at 90 C. using SO₃ and ozone. The patterned resist had been implanted above the E15 level, and had not been significantly removed by running this process at ambient temperature process. At the higher temperature, the attack is significant, as shown in FIG. 9. However, as shown in FIG. 10, by processing with ozone and with wetting the surface with sulfuric acid, resist removal was complete.

The use of sulfuric acid may be of limited value in some cases. In one test case, blanket photoresist wafers had been implanted to 1E15 and then partially ashed. Whether sulfuric acid was used or not, resist removal in a 90 second process was incomplete. The primary mechanism for the resist removal appears to be a lift-off process. The resist is severely attacked, but does not necessarily completely react to form CO₂. Blanket films are more difficult to lift off than are fine pattern geometries, and the partial ashing seems to harden the photoresist to a significant degree. In other cases, the resist removal is so fast that it is complete regardless of whether or not sulfuric acid is used.

Using the processes described here, moderate implants, in the E14 range, photoresist was stripped using just sulfuric acid (98% H₂SO₄) at temperatures in the range of 150° C. Wafers with As implant at 2.5E16 were stripped using H₂SO₄ and SO₃ with and without O₃.

At temperatures in the range of 90° C., the addition of ozone in conjunction with H₂SO₄ and SO₃ clearly improved the photoresist strip. However, at temperatures in the range of 150° C. or greater the benefits of the ozone were less clear. However, it is clear that the additional oxidative capability of the SO₃ when applied in conjunction with liquid H₂SO₄ does allow stripping of high dose implants.

Recognizing that the SO₃ must dissolve into the sulfuric acid film on the wafer to be effective, in another set of testing, fuming sulfuric acid (30% by weight SO₃ dissolved in H₂SO₄) was used instead of sulfuric acid and SO₃ vapor. The fuming sulfuric acid was applied to the resist samples prior to heating the samples to 140° C.-160° C. This achieved good results. However, one sample which was a combined As and P implant at 5E15 which was very difficult to strip. By reducing the process temperature to about 90° C. for 3:00 minutes, in the presence of ozone, and then heating to 160° C. for a final 2:00 minutes, still in the presence of ozone, the photoresist was completely removed when the sample was spray rinsed at the sink (although the photoresist did not appear to be fully oxidized). This indicates that the exceptionally hardened photoresist may be removed via a lift-off process rather than through oxidation. Inspection using an optical microscope indicates that the smallest features are the most difficult to remove, as these features likely have been the most severely hardened in the implant. Reducing the process temperature avoids the potential of driving the SO₃ out of solution in the H₂SO₄ on the wafer surface.

In a manually operated laboratory set up, the following results were achieved:

| Sample | Implant | Photoresists | Process | Comment |
|---|---|---|---|---|
| DR 1325 | 5.00E+15 | 10,000A KrF | Fuming | Pattern film. Clean |
| | | | sulfuric, 3:00 | strip, no change in |
| | | | 160 C. | underlying 200A oxide |
| DR 1370 | 2.5E16 80 KeV | No | Fuming | Pattern film. Clean |
| | | information | sulfuric, 3:00 | strip |
| | | | 160 C. | |
| DR 1163 | 5E15 As and P | Unknown | Fuming | Clear after rinse. |
| | | energy | sulfuric + O3, | |
| | | | ramped temp. | |
| | | | 2:00 90 C. > 2:00 | |
| | | | 160 C. | |
| DR 1163 | 3E15 B | Unknown | Fuming | Pattern film. Clean |
| | | energy | sulfuric, 3:00 | strip |
| | | | 160 C. | |
| DR 1284 | 3E15 40 KeV | unknown | Fuming | Pattern film. Clean |
| | | implant | sulfuric, 2:00, | strip, no change in |
| | | species, 248 nm | 140 C. | underlying 1000A oxide |
| DR 1419 | 1.5E15 BF2 | 2500A 248 nm? | 60″ fuming | Total strip in 90 |
| | | Seems | sulfuric + 30″ | seconds at 160 C. |
| | | more like 193 nm | peroxide | Previously unsuccessful |
| | | | addition | on this resist. Time |
| | | | | reduced by 50%. |
| DR 1526 | 3.50E+16 | 193 nm | 2:00 fuming | Total strip at 160 C., not |
| | | | sulfuric + 30″ | successful without |
| | | | peroxide | peroxide |
| | | | addition | |
| DR 1517 | 3E15 As | DUV 300A? | 2:30 fuming | Total strip at 160 C., |
| | | | sulfuric + 30″ | residues floating in film |
| | | | peroxide | without peroxide. |
| | | | addition | |

Initial tests looking at the etch rate on common FEOL films such as TOX, SiN and Polysilicon show less than a 1A change in film thickness after a 10:00 170° C. H₂SO₄/SO3/O₃ process. This is similar to the film thickness repeatability checks performed, so the film thickness change is essentially within the noise level of the measurement equipment.

### D. Apparatus

FIG. 11 schematically shows an example of a system 20 for removing photoresist, using the methods described above. In this single wafer processing example, a spin motor 26 spins a rotor 24 holding a wafer 30 within a chamber 22. A sulfuric acid source 34 supplies sulfuric acid to one or more spray or atomization nozzles 38 via a metering pump 36. A sulfur trioxide supply 40 provides sulfur trioxide gas into the process chamber 22. A heating system 52 may be associated with the sulfur trioxide supply 40. Alternatively, a source of fuming sulfuric acid may be used. Hydrogen peroxide is supplied to the chamber 22 from a hydrogen peroxide source 42, via a metering pump 44. The hydrogen peroxide may be sprayed onto the wafer as a spray, mist or aerosol formed by one or more nozzles 545. For processes using ozone, an ozone generator 32 may provide ozone gas into the chamber 22.

The system 20 may also have rinse capability via a rinse water supply 46 connecting to nozzles in the chamber 22. Ammonia may optionally be pumped from a source 48 via a metering pump 50 into the rinse water. The chamber 22 may have one or more quartz windows 56, with an infrared heater 54 outside of the chamber irradiating and heating the wafer within the chamber via radiation through the window. FIG. 11 shows the wafer 30 in a face down orientation, with the process chemicals projected up to the wafer. The wafer 30 may of course also be face up, vertical, or in any orientation, as gravity forces are largely dominated by fluid, inertial and centrifugal forces. The system 20 may also be set up as a batch processor. The methods described apply to single wafer processing and to batch processing.

1-4. (canceled)

5. A method for stripping photoresist from a semiconductor wafer comprising:
placing the wafer into a chamber having a gas or air environment;
heating the wafer;
spinning the wafer;
applying fuming sulfuric acid to the surface of the wafer, with the fuming sulfuric acid forming a liquid layer on the surface of the wafer;
with the fuming sulfuric acid chemically reacting with the photoresist to remove the photoresist from the wafer.

6. The method of claim 5 with the wafer heated to 25-200° C.

7. The method of claim 5 wherein the wafer is heated by heating the liquid and then applying the heated liquid onto the wafer.

8. The method of claim 5 wherein the wafer is heated via radiation or conduction.

9. The method of claim 5 further comprising providing ozone gas into the chamber.

10. The method of claim 5 further comprising applying hydrogen peroxide to the liquid layer.

11. The method of claim 5 further comprising controlling the thickness of the liquid layer.

12. The method of claim 11 further comprising controlling the spin speed or flow rate of liquid onto the wafer.

13. (canceled)

14. The method of claim 13 wherein the hydrogen peroxide is applied to the liquid layer 30-240 seconds after applying the fuming sulfuric acid.

15. A method for stripping photoresist from a semiconductor wafer comprising:
placing the wafer into a chamber;
sealing the chamber;
heating the wafer;
spinning the wafer;
forming a liquid layer of de-ionized water on the surface of the wafer;
controlling the thickness of the liquid layer on the surface of the wafer;
providing sulfur trioxide into the chamber, with the sulfur trioxide contacting and reacting with the water to form sulfuric acid;
applying hydrogen peroxide to the liquid layer, with the sulfuric acid and the hydrogen peroxide chemically reacting with the photoresist to remove the photoresist from the wafer.

16. The method of claim 15 further comprising providing ozone gas into the chamber.

17-19. (canceled)

20. A method of removing an organic film from a workpiece, comprising:
placing the workpiece into a chamber;
applying a liquid film comprising sulfuric acid to the workpiece, with the sulfuric acid at a first temperature;
spinning the workpiece;
controlling the thickness of the liquid film;
heating the sulfuric acid on the workpiece to a second temperature higher than the first temperature; and
applying hydrogen peroxide to the liquid film after the sulfuric acid is heated up to the second temperature.

21. The method of claim 20 wherein the hydrogen peroxide is applied beginning at a predetermined time interval after the sulfuric acid reaches the second temperature.

22. The method of claim 20 further comprising introducing ozone gas into the chamber.

23. The method of claim 21 further comprising heating the workpiece to a temperature of about 30-300° C.

24. The method of claim 20 wherein the acid comprises fuming sulfuric acid.

25. The method of claim 21 wherein the predetermined time interval is from 10-120 seconds.

26-27. (canceled)
